(19) United States
(12) Patent Application Publication
(10) Pub. No.: US 2021/0262422 A1
(43) Pub. Date: Aug. 26, 2021

(54) HEAT EXCHANGER HOUSING AND METHOD OF MANUFACTURING A HEAT EXCHANGER

(71) Applicant: Faurecia Emissions Control Technologies, Germany GmbH, Augsburg (DE)

(72) Inventors: David Saurat, Augsburg (DE); Otto Steinhauser, Augsburg (DE)

(21) Appl. No.: 17/164,991

(22) Filed: Feb. 2, 2021

(30) Foreign Application Priority Data
Feb. 20, 2020 (DE) 10 2020 104 538.7

(51) Int. Cl. F02M 26/29; F28D 21/00; F28F 9/02

(52) U.S. Cl. CPC F02M 26/29; F28F 9/0219; F28D 21/0003

(57) ABSTRACT

A heat exchanger housing for an exhaust gas heat recovery system or an exhaust gas cooler of a motor vehicle includes a first housing shell, which forms a side wall of the heat exchanger housing and at least one end piece that is on at least one end face of the first housing shell that delimits the heat exchanger housing. Both the first housing shell and the at least one end piece have an end face, and the end faces are directly opposite each other. A second housing shell forms several side walls of the heat exchanger housing. The first and second housing shells are soldered to one another and to the at least one end piece. Furthermore, a method for producing a heat exchanger is specified.

### CROSS-REFERENCE TO RELATED APPLICATIONS

This application is a U.S. non-provisional application claiming the benefit of German Application No. 10 2020 104 538.7, filed on Feb. 20, 2020, which is incorporated herein by reference in its entirety.

### TECHNICAL FIELD

The disclosure relates to a heat exchanger housing for a heat exchanger of an exhaust heat recovery system or of an exhaust gas cooler of a motor vehicle, and to a method of manufacturing a heat exchanger for a motor vehicle.

### BACKGROUND

Heat exchanger housings usually consist of a number of housing components which are joined to each other by brazing. Gaps usually occur at the interfaces between the housing parts and are filled by the brazing material during brazing. This results in a relatively high demand for brazing filler, which has a negative effect on manufacturing costs. In addition, high gaps (>0.8 mm) result in an incomplete brazing, which may lead to a leakiness of the part and thus to a loss of function.

### SUMMARY

An optimized heat exchanger housing and a method of manufacturing a heat exchanger is provided. In one example, the disclosure provides a heat exchanger housing for an exhaust heat recovery system or an exhaust gas cooler of a motor vehicle, including a first housing shell which forms a side wall of the heat exchanger housing. At least one end piece is arranged on at least one face side of the first housing shell and delimits the heat exchanger housing, wherein both the first housing shell and the at least one end piece have a face side terminating surface, and wherein the face side terminating surfaces are directly opposite each other. A second housing shell forms a plurality of side walls of the heat exchanger housing, wherein the first and second housing shells are brazed to each other and to the at least one end piece.

The fundamental idea of the disclosure is based on avoiding gaps between the individual housing parts or keeping them as small as possible in order to optimize the manufacture of the heat exchanger housing.

The small gap sizes resulting from the design according to the disclosure make it possible to join the housing parts to each other by furnace brazing. This allows a particularly cost-effective and simple manufacture of the heat exchanger housing. In addition, by avoiding or minimizing gaps, the need for brazing material, e.g. brazing paste, is minimized, which also has an advantageous effect on manufacturing costs.

The terminating surfaces are understood to mean those surfaces of the first housing shell and the end piece, respectively, which, as viewed in the longitudinal direction of the heat exchanger housing, extend toward the opposite component to the maximum extent.

The face side terminating surfaces of the first housing shell and of the end piece rest in particular against each other or are oriented parallel to each other at a distance. The distance is preferably relatively small, in particular less than 0.8 mm, and corresponds at most to the wall thickness of the housing shell, for example.

When the terminating surfaces rest against each other, an outer surface of the first housing shell and an outer surface of the end piece form a continuous, smooth surface.

The terminating surface of the first housing shell is in full surface contact with the terminating surface of the end piece here. That is, the terminating surface of the end piece is at least as large as the terminating surface of the housing shell.

The term smooth means that an outer surface of the first housing shell transitions flush into an outer surface of the end piece and, in particular, that there is no protruding edge on an outer surface of the housing at a transition from the first housing shell to the end piece. However, this does not rule out the existence of stamped portions, such as stiffening beads or other widened portions, elsewhere in the housing shell or the end piece.

By avoiding a protruding edge, gaps between the second housing shell and the end piece or the first housing shell can also be avoided.

Viewed in the longitudinal direction, the first housing shell and the at least one end piece are preferably arranged relative to each other without overlapping.

In a face side view, the first housing shell is U-shaped, for example.

The first housing shell forms, for example, the bottom of the heat exchanger housing, while the second housing shell forms two opposite side walls and a top face of the heat exchanger housing.

According to one example, a fixing element is provided, which partly overlaps the first housing shell and partly overlaps the end piece and is fastened to the first housing shell and/or the end piece, e.g. by joining, which primarily includes welding, bonding or crimping. The fixing element allows the end piece to be pre-assembled to the housing shell. In particular, the end piece may be captively held to the housing shell in a defined position by the fixing element before the parts are brazed to one another.

By having the fixing element overlap the first housing shell and the end piece, the fixing element can furthermore serve to cover a gap between the face side terminating surfaces of the first housing shell and of the end piece. In addition, the fixing element enhances the stability of the heat exchanger housing.

The fixing element is strip-shaped, for example, and has an outer surface that is in surface contact with the first housing shell and the end piece. The fixing element thus covers the interface between the first housing shell and the end piece on an inside of the heat exchanger housing. In this way, a labyrinth effect is produced so that brazing metal, which in a heated state has an especially low viscosity, cannot run into an interior space of the heat exchanger housing.

For example, the fixing element overlaps both the first housing shell and the end piece by at least 3 mm each.

According to one example, the end piece is defined by an end grid. In this way, a flow inlet or flow outlet into the heat exchanger housing is formed in the end piece at the same time.

According to a further example, the end piece is a conical connecting piece for connection to an exhaust line of a motor vehicle. The connecting piece may serve as an exhaust gas inlet or an exhaust gas outlet into the heat exchanger housing.

If the end piece is a connecting piece for connection to an exhaust line of a motor vehicle, the fixing element may be formed by an end grid. This allows the number of necessary components to be kept low. In particular, the end grid can additionally fulfill all the functions described above in connection with the fixing element.

Preferably, the second housing shell is placed on the first housing shell, with edges of the housing shells overlapping and being joined by brazing. The overlap allows manufacturing tolerances to be compensated. In particular, owing to the overlap, the occurrence of a gap is avoided.

In particular, the second housing shell is also of a U-shaped configuration and, together with the first housing shell, it constitutes a circumferential housing wall.

Furthermore, the second housing shell may overlap the end piece, the brazed joint being provided in the overlap area. In this way, the occurrence of gaps due to manufacturing tolerances is also avoided between the end piece and the second housing shell.

In addition, the overlap of the second housing shell and the first housing shell and/or the end piece enhances the stability of the heat exchanger housing.

Preferably, a braze metal is applied to an outer surface of the heat exchanger housing along an interface between the first housing shell and the end piece and/or along an interface between the first housing shell and the second housing shell and/or along an interface between the second housing shell and the end piece.

According to one example, a respective end piece is arranged on both sides of the first housing shell. This allows the heat exchanger housing to be manufactured particularly well by furnace brazing.

The object is further achieved according to the disclosure by a method of manufacturing a heat exchanger for a motor vehicle, in particular having a heat exchanger housing that is configured as described above, including the steps of:

providing a first housing shell which forms a side wall of a heat exchanger housing, and at least one end piece;

using a joining method, pre-fixing the first housing shell and the at least one end piece in relation to each other in a position in which a face side terminating surface of the first housing shell and a face side terminating surface of the at least one end piece are directly opposite each other;

placing a second housing shell onto the first housing shell, in particular such that the second housing shell overlaps the first housing shell and/or the at least one end piece at the edges; subsequently

applying or introducing a brazing material, e.g. a brazing paste, onto or into the interfaces between the first housing shell and the at least one end piece and also between the second housing shell and the at least one end piece and between the first and second housing shells; and

furnace brazing the heat exchanger housing.

Such a method allows a particularly simple and cost-effective manufacture of a heat exchanger in which, compared with conventional methods, the amount of brazing material required is particularly small.

Using furnace brazing, the interfaces between the housing parts can be sealed to make them fluid-tight.

Prior to the placement of the second housing shell, a heat exchanger core is preferably inserted into the first housing shell. Assembly of the heat exchanger core can thus be effected particularly simply.

Prior to the furnace brazing and preferably also prior to insertion of the heat exchanger core into the first housing shell, at least one fixing element is arranged on an inner surface of the heat exchanger housing in an overlapping relationship with the first housing shell and with the end piece. As already described above, the fixing element serves to pre-fix the first housing shell and the end piece relative to each other.

### BRIEF DESCRIPTION OF THE DRAWINGS

FIG. 1 shows an exploded view of a heat exchanger housing according to an example of the disclosure;

FIG. 2 shows the heat exchanger housing of FIG. 1 in an assembled state;

FIG. 3 shows the heat exchanger housing of FIG. 1 in a front view;

FIG. 4 shows a detailed view of an interface between a first housing shell and an end piece of the heat exchanger housing as viewed from an inside of the housing;

FIG. 5 shows a longitudinal section taken through part of the heat exchanger housing;

FIG. 6 shows an exploded view of a heat exchanger housing according to a further example of the disclosure;

FIG. 7 shows the heat exchanger housing from FIG. 6 in an assembled state;

FIG. 8 shows a further view of the heat exchanger housing of FIG. 7;

FIG. 9 shows a cross-section through the heat exchanger housing of FIG. 7 in a top view;

FIG. 10 shows a cross-section through the heat exchanger housing of FIG. 7 in a perspective view;

FIG. 11 shows a detailed view of the heat exchanger housing from FIG. 7 in the region of an interface between a first housing shell, a second housing shell and an end piece;

FIG. 12 shows a detailed area from a further cross-section through the heat exchanger housing of FIG. 7; and

FIG. 13 shows a longitudinal section taken through part of a further heat exchanger housing according to the disclosure.

### DETAILED DESCRIPTION

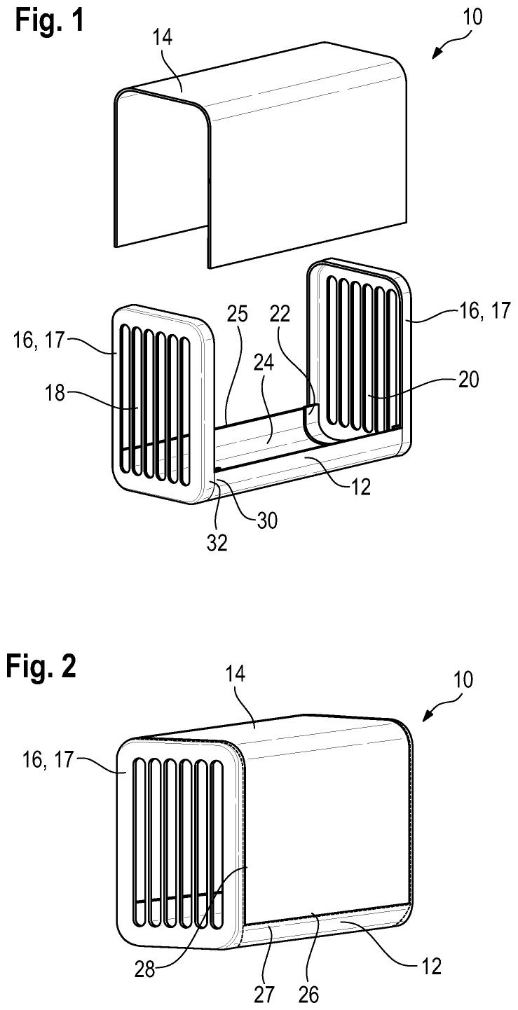

FIG. 1 shows a heat exchanger housing 10 for an exhaust heat recovery system or an exhaust gas cooler of a motor vehicle. The heat exchanger housing 10 is composed of a first housing shell 12, a second housing shell 14, and two end pieces 16.

The first housing shell 12 forms a bottom of the heat exchanger housing 10, while the second housing shell 14 forms a top side and two side walls of the heat exchanger housing 10. The end pieces 16 delimit the heat exchanger housing 10 on the face sides.

In the exemplary example illustrated, the two end pieces 16 are in the form of an end grid 17 and constitute an inlet 18 into the heat exchanger housing 10 and an outlet 20 from the heat exchanger housing 10. This means that exhaust gas can flow through the end pieces 16 into and/or out of the heat exchanger housing 10. To this end, flat gas ducts, which constitute the so-called heat exchanger core, are inserted within the openings of the grid.

The heat exchanger housing 10 further comprises a fixing element 22, which is arranged on an inner wall 24 of the heat exchanger housing 10 and which partly overlaps the first housing shell 12 and partly overlaps the end piece 16. Here, the fixing element 22 is fastened to both the first housing shell 12 and the end piece 16, in particular welded, for example by spot welding or laser welding.

In the exemplary example illustrated, the fixing element 22 is strip-shaped, for example a metal sheet. It extends at least up to an upper edge 25 of the first housing shell 12. In the illustrated exemplary example, the fixing element 22 protrudes somewhat beyond the upper edge 25 of the first housing shell 12. In this way, an interface between the first housing shell 12 and the end piece 16 is completely covered by the fixing element 22.

Both the first housing shell 12 and the second housing shell 14 are U-shaped in a face side view.

FIG. 2 shows the heat exchanger housing 10 from FIG. 1 in an assembled state, with the second housing shell 14 placed on the first housing shell 12. The edges 26, 28 of the second housing shell 14 overlap the edges 27 of the first housing shell 12 and the end piece 16.

The housing shells 12, 14 are brazed to each other as well as to the end pieces 16. The brazing of the second housing shell 14 to the first housing shell 12 and to the end pieces is provided in the overlap area. In FIG. 2, the brazed joint is illustrated by dashed lines.

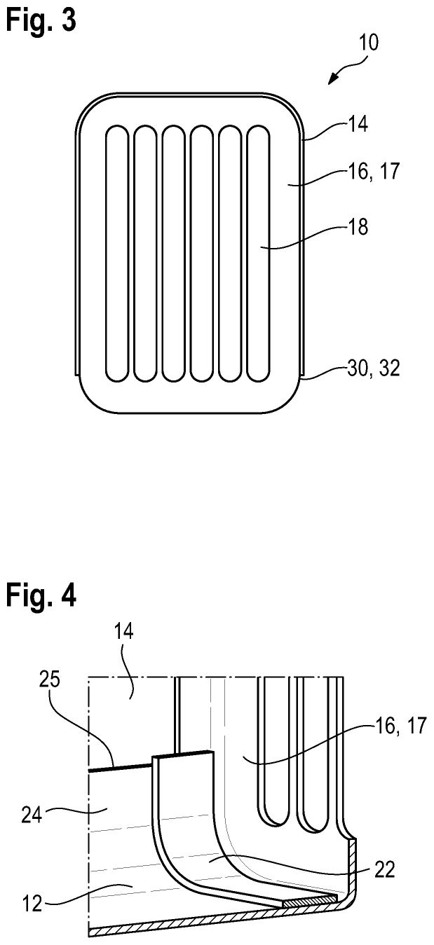

In the front view in FIG. 3, it can be seen that the first housing shell 12, when viewed from the front, does not protrude beyond the end piece 16. Therefore, in the front view, the first housing shell 12 is concealed by the end piece 16. More precisely, an outer surface 30 of the first housing shell 12 smoothly transitions into an outer surface 32 of the end piece 16.

FIG. 4 shows a detailed view of the inner wall 24 of the heat exchanger housing 10 in the area of an interface between an end piece 16, the first housing shell 12 and the second housing shell 14.

As can be seen in FIG. 4, the fixing element 22 has an outer surface that is in surface contact with the first housing shell 12 and the end piece 16.

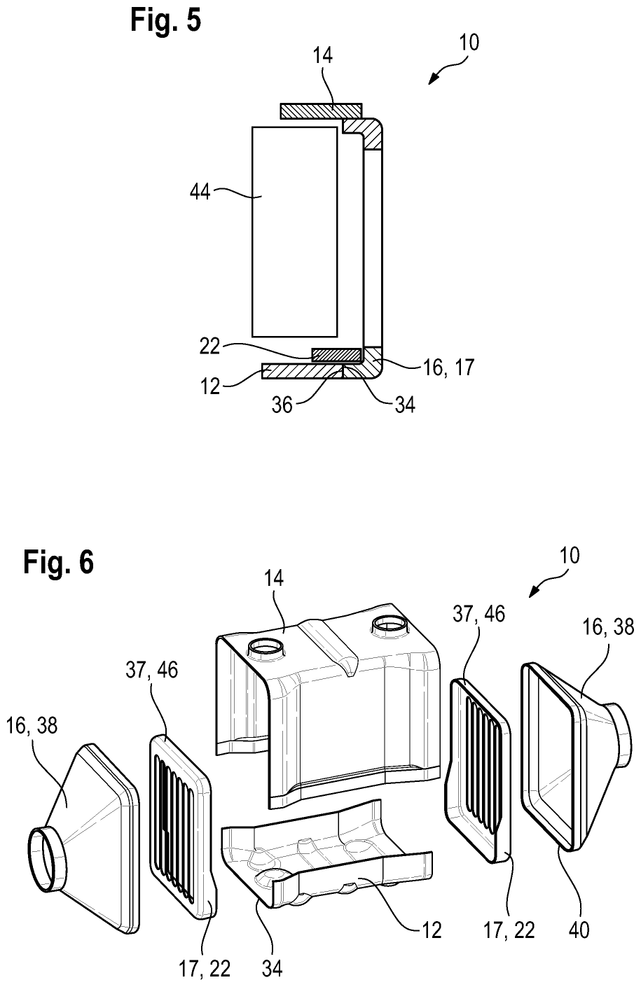

As can be seen in the sectional view in FIG. 5, the first housing shell 12 has a face side terminating surface 34 on each side and the end pieces 16 also each have a face side terminating surface 36.

The terminating surface 36 of the end pieces 16 is formed on a circumferential collar 37 of the end grid 17 here.

In the assembled state of the heat exchanger housing 10, a face side terminating surface 34 of the first housing shell 12 is directly opposite the respective face side terminating surface 36 of an end piece 16. In particular, the terminating surfaces 34, 36 rest against each other.

More precisely, the face side terminating surface 34 of the first housing shell rests over its entire surface against the face side terminating surface 36 of the end piece 16, the terminating surface 36 of the end piece 16 being formed to be congruent, at least in sections, with the terminating surface 34 of the first housing shell 12.

Also shown schematically in the sectional view of FIG. 5 is a heat exchanger core 44, which can be inserted in the heat exchanger housing 10 to form a heat exchanger.

FIGS. 6 to 12 show a further example of a heat exchanger housing 10.

The heat exchanger housing 10 differs from the heat exchanger housing 10 according to FIGS. 1 to 5, for one thing, in that the end pieces 16 are not formed by the end grid 17, but by two conical connecting pieces 38 for connection to an exhaust line of a motor vehicle.

Like the end grid 17 shown in FIGS. 1 to 5, the connecting pieces 38 also have a terminating surface 40 which, in the same way as the terminating surface 36 of the end grid 17, is directly opposite the terminating surface 34 of the first housing shell 12, in particular rests against it.

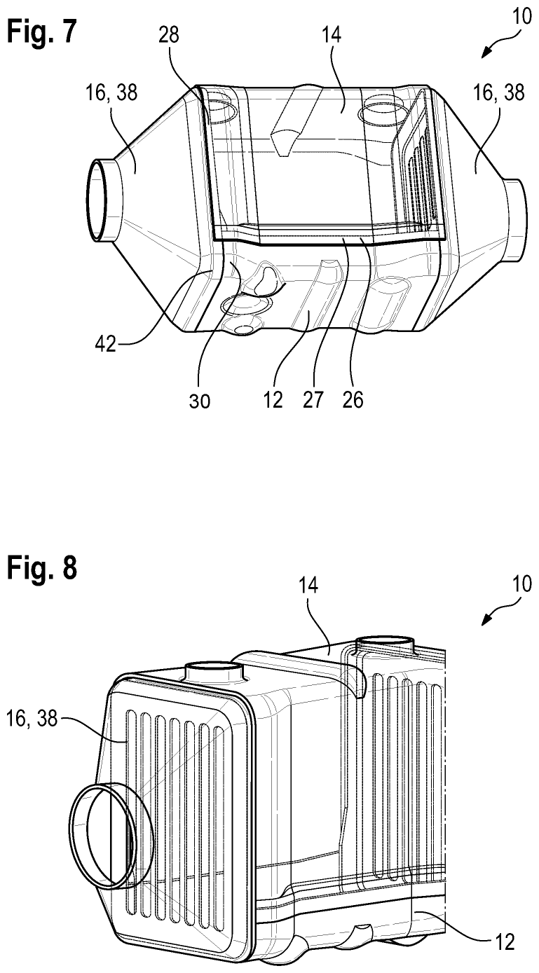

Here, the outer surface 30 of the first housing shell 12 smoothly continues into an outer surface 42 of the connecting piece 38, as can be seen in FIG. 7, which shows the heat exchanger housing 10 of FIG. 6 in an assembled state, in which the second housing shell 14 has been placed on the first housing shell 12.

In this example, the end grids 17 constitute the fixing elements 22, that is, the end grid 17 overlap the connecting pieces 38 and the first housing shell 12 and are welded to the connecting piece 38 and to the first housing shell 12.

For this purpose, an outer surface 46 of the circumferential collar 37 of the end grid 17 rests against the inner wall 24 of the heat exchanger housing 10.

The second housing shell 14 is shown transparent in FIG. 7 for better illustration. It can thus be seen that the edges 26, 28 of the second housing shell 14 overlap the first housing shell 12 and the end pieces 16.

The housing shells 12, 14 are brazed to one another and to the end pieces 16 in the same manner as in the example described in connection with FIGS. 1 to 5.

FIG. 8 also shows the heat exchanger housing 10 in an assembled state, with the end piece 16 and the upper housing shell 14 being illustrated transparent. In this way, it can be seen particularly well how the end grid 17, which form the fixing elements 22, are arranged in the heat exchanger housing 10.

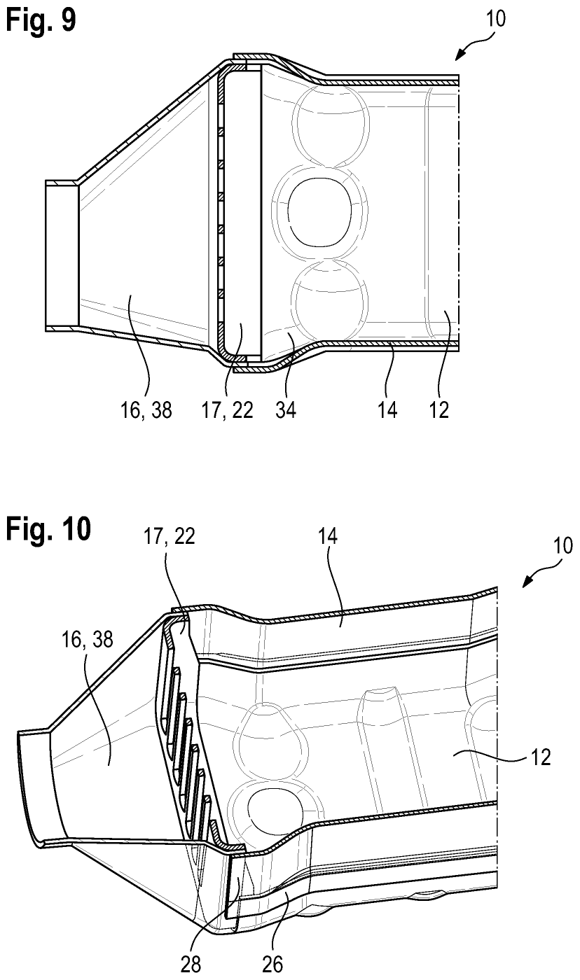

In the sectional view in FIG. 9, the overlap between the end grid 17 and the first housing shell 12 as well as the end piece 16, and also the overlap between the second housing shell 14 and the end piece 16 can be seen particularly well.

The sectional view of FIG. 10 includes a semitransparent illustration of the second housing shell 14 and the end piece 16. This makes it particularly easy to see how the second housing shell 14, along its edges 26, 28, overlaps the first housing shell 12 and the end piece 16. As already described in connection with FIGS. 1 to 5, a brazed joint is present in the overlap area in this example as well.

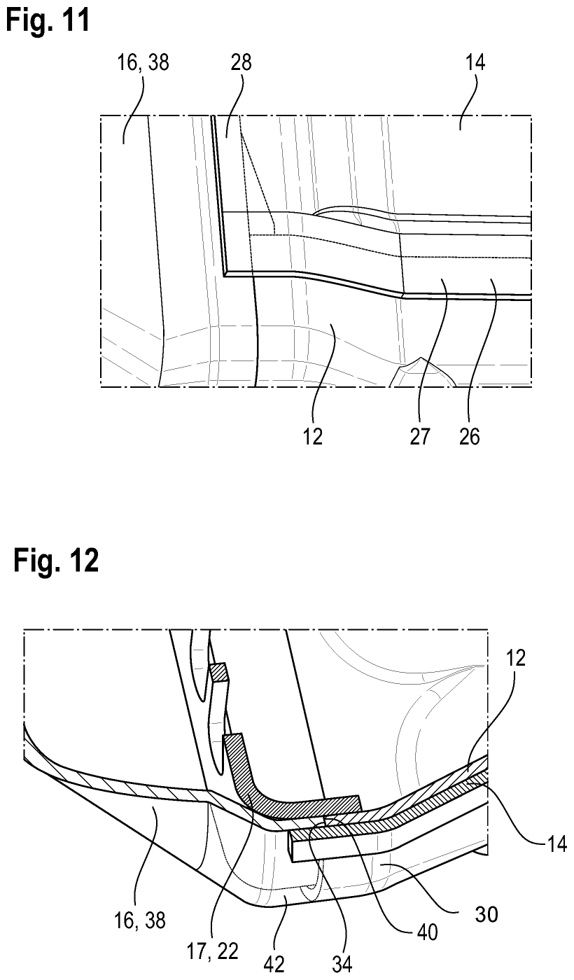

FIG. 11 shows a detailed view of an overlap area at an interface between the first housing shell 12, the second housing shell 14 and the end piece 16, with the second housing shell shown semitransparent here as well to illustrate the overlap.

In the detailed view in FIG. 12, the engagement of the terminating surfaces 34, 40 with each other can be seen particularly clearly. It can be seen that here, too, the outer surface 30 of the first housing shell 12 continues into the outer surface 42 of the end piece 16 in alignment. This transition in alignment allows the second housing shell 14 to be in full-surface contact along the edges 26, 28.

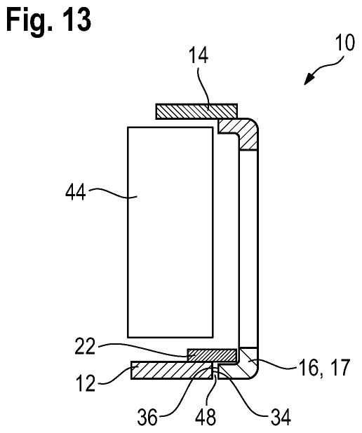

In a further alternative example, which is illustrated in FIG. 13 with the aid of a sectional view, a small gap 48 may be provided between the first housing shell 12 and the end piece 16. This gap is preferably at most as large as the wall thickness of the first housing shell 12. Toward the interior of the housing, the gap 48 is closed by the fixing element 22.

The manufacture of a heat exchanger with a heat exchanger housing 10 will now be described below. The manufacturing process is the same, irrespective of which of the two previously described heat exchanger housings 10 is used.

First, a first housing shell 12 and two end pieces 16 are provided.

The housing shell 12 and the end pieces 16 are pre-fixed in relation to each other, more specifically in a position in which a face side terminating surface 34 of the first housing shell 12 is directly opposite a respective face side terminating surface 36, 40 of the end pieces 16, and the terminating surfaces 34, 36, 40 rest against each other.

The pre-fixing is carried out using a joining method, e.g. a welding method, although adhesive bonding or crimping are also conceivable. More precisely, the pre-fixing is effected by the fixing elements 22, more particularly by arranging the fixing elements 22 on an inner surface of the heat exchanger housing 10 in such a way that each of the fixing elements 22 overlaps the first housing shell 12 and one of the end pieces 16. Subsequently, the fixing elements 22 are connected to the first housing shell 12 and to an end piece 16 by spot welding or laser welding, for example, or are otherwise joined thereto. However, it is also conceivable to dispense with the fixing elements 22 and to weld the first housing shell 12 and the end pieces 16 directly to each other.

Before the second housing shell 14 is placed on the first housing shell 12 and the end pieces 16, the heat exchanger core 44 is inserted.

After the heat exchanger core 44 has been inserted, the second housing shell 14 is placed on the first housing shell 12, in particular in such a way that the second housing shell 14 overlaps the first housing shell 12 and the end piece 16 at the edges.

Once the housing parts 12, 14, 16 have been assembled, a brazing material, e.g. a brazing paste, is applied on or introduced into the interfaces between the first housing shell 12 and the end piece 16 and the interfaces between the second housing shell 14 and the end piece 16 as well as the interfaces between the two housing shells 12, 14. The interfaces to which brazing material is applied or into which brazing material is introduced are illustrated by dashed lines in FIG. 2.

Thereafter, the heat exchanger housing 10 is finished by furnace brazing, in particular in a vacuum furnace.

Although various embodiments have been disclosed, a worker of ordinary skill in this art would recognize that certain modifications would come within the scope of this disclosure. For that reason, the following claims should be studied to determine the true scope and content of this disclosure.

1. A heat exchanger housing for an exhaust heat recovery system or an exhaust gas cooler of a motor vehicle, comprising:
a first housing shell which forms a side wall of the heat exchanger housing;
at least one end piece that is arranged on at least one face side of the first housing shell and delimits the heat exchanger housing, wherein both the first housing shell and the at least one end piece have a face side terminating surface, and wherein the face side terminating surfaces are directly opposite each other; and
a second housing shell which forms a plurality of side walls of the heat exchanger housing, wherein the first and second housing shells are brazed to each other and to the at least one end piece.

2. The heat exchanger housing according to claim 1, wherein a fixing element partly overlaps the first housing shell and partly overlaps the at least one end piece and is fastened, in particular welded, to the first housing shell and/or the at least one end piece.

3. The heat exchanger housing according to claim 2, wherein the fixing element is welded to the first housing shell and/or the at least one end piece.

4. The heat exchanger housing according to claim 2, wherein the fixing element is strip-shaped and has an outer surface that is in surface contact with the first housing shell and the at least one end piece.

5. The heat exchanger housing according to claim 1, wherein the at least one end piece is formed by an end grid.

6. The heat exchanger housing according to claim 1, wherein the at least one end piece is a conical connecting piece for connection to an exhaust line of a motor vehicle.

7. The heat exchanger housing according to claim 6, wherein a fixing element is provided, which partly overlaps the first housing shell and partly overlaps the conical connecting piece and is fastened to the first housing shell and/or the conical connecting piece.

8. The heat exchanger housing according to claim 7, wherein the fixing element is formed by an end grid.

9. The heat exchanger housing according to claim 1, wherein the first housing shell is U-shaped in a face side view.

10. The heat exchanger housing according to claim 1, wherein the second housing shell is placed on the first housing shell, and edges of the first and second housing shells overlap and are joined by brazing.

11. The heat exchanger housing according to claim 10, wherein the second housing shell overlaps the at least one end piece and a brazed joint is provided in an overlap area.

12. The heat exchanger housing according to claim 1, wherein the at least one end piece comprises a respective end piece that is arranged on either side of the first housing shell.

13. A method of manufacturing a heat exchanger for a motor vehicle, comprising the steps of:
providing a first housing shell which forms a side wall of a heat exchanger housing, and at least one end piece;
using a joining method, pre-fixing the first housing shell and the at least one end piece in relation to each other in a position in which a face side terminating surface of the first housing shell and a face side terminating surface of the at least one end piece are directly opposite each other;
placing a second housing shell onto the first housing shell, in particular such that the second housing shell overlaps the first housing shell and/or the at least one end piece at edges of the first and second housing shells and/or the at least one end piece; subsequently
applying or introducing a brazing material onto or into interfaces between the first housing shell and the at least one end piece and also between the second housing shell and the at least one end piece and between the first and second housing shells; and
furnace brazing the heat exchanger housing.

14. The method according to claim 13, wherein prior to placement of the second housing shell, a heat exchanger core is inserted into the first housing shell.

15. The method according to claim 13, wherein prior to furnace brazing, at least one fixing element is arranged on an inner surface of the heat exchanger housing in an overlapping relationship with the first housing shell and the at least one end piece.

16. The method according to claim 13, wherein the heat exchanger housing is a housing for an exhaust heat recovery system or an exhaust gas cooler of a motor vehicle, comprising the first housing shell which forms the side wall of the heat exchanger housing, wherein the at least one end piece is arranged on at least one face side of the first housing shell and delimits the heat exchanger housing, wherein both the first housing shell and the at least one end piece have face side terminating surfaces, and wherein the face side terminating surfaces are directly opposite each other, and further comprising the second housing shell which forms a plurality of side walls of the heat exchanger housing, wherein the first and second housing shells are brazed to each other and to the at least one end piece.
